(19) United States
(12) Patent Application Publication
(10) Pub. No.: US 2026/0340154 A1
(43) Pub. Date: Oct. 29, 2026

(54) SECURE COMPUTATION APPARATUS, SECURE RANK UPDATE METHOD, AND PROGRAM

(71) Applicant: NTT, Inc., Tokyo (JP)

(72) Inventor: Junko HASHIMOTO, Tokyo (JP)

(73) Assignee: NTT, Inc., Tokyo (JP)

(21) Appl. No.: 19/486,375

(22) PCT Filed: May 23, 2023
(86) PCT No.: PCT/JP2023/019039

§ 371 Date: Nov. 20, 2025

(51) Int. Cl. G06F 21/60

(52) U.S. Cl. CPC G06F 21/602

(57) ABSTRACT

To add/delete a record to/from a table that is securely distributed, it is desired to update rank data again without using concealing and sorting. Therefore, according to a first aspect of the present disclosed technology, a secure computation device includes a rank data update unit that specifies an insertion rank of an additional record by a secure comparison operation and updates rank data of a record based on the insertion rank. In addition, according to a second aspect of the present disclosed technology, a secure computation device includes a rank data update unit that updates a rank of a record based on rank data of a deletion record.

### TECHNICAL FIELD

The disclosed technology relates to a method in which a secure computation system that stores data securely distributed and performs secure computation handles data indicating a rank.

### BACKGROUND ART

In a general encryption scheme, even though data desired to be concealed is encrypted and stored in a server, decryption is performed, and then computation is performed by using these values.

On the other hand, a secure computation technology is technology capable of performing computation in a state where data is encrypted (Reference Literature 1). Reference Literature 1 discloses a multi-party protocol in which one numerical value is converted into a plurality of encrypted shares, each of N secure computation devices has a share, and each secure computation device performs addition, multiplication, logical operation, and the like without leaking information of its own share.

Reference Literature 1: Koji Chida, et al., “Reconsideration of lightweight verifiable three-party secure function computation”, CSS 2010.

In the secure computation system, the data size strongly affects the performance. In a case where category data is handled, it is possible to improve the performance by converting the category data (category ID or category name) having the redundancy into a category value having a smaller bit number and managing the category value. The secure computation for the category value includes condition determination, creation of a quantity table using the category value as a key value, sorting, and the like. For example, Non Patent Literature 1 discloses sorting by secure computation.

In addition, in the statistical operation, there is category data having a rank called factor type. For this, a category value maintaining a magnitude relationship is assigned to the category data.

In addition, when sorting is performed, information regarding the rank of the data is held therein. This rank data can be used for the category value.

### CITATION LIST

### Non Patent Literature

Non Patent Literature 1: Dai Ikarashi, et al, “A Design and an Implementation of Super-High-Speed Multi-Party Sorting: The Day When Multi-Party Computation Reaches Scripting Languages”, Papers of Computer Security Symposium 2017, pp. 600-607.

### SUMMARY OF INVENTION

### Technical Problem

In a case where the category value of the factor type or the rank data of sorting is encrypted and stored in a DB, the information may be updated later. Specific examples are as follows.
(1) The rank data is obtained by concealing and sorting the data, but since data is added/deleted to/from the original data, the rank is updated again.
(2) Regarding the ranked category data (mapping of category ID and category value), category values are calculated by concealing and sorting the category IDs, and correspondence between the category IDs and the category values is managed by a category management table. However, since the category ID is added/deleted, the category management table is updated.

In the known method, in the case of (1), after data is added/deleted, all pieces of data are concealed and sorted again, and the rank data is updated. However, concealing and sorting is heavy processing, and the processing amount is proportional to the number of pieces of data. Therefore, even in a case where only one piece of data is added, heavy processing is required.

In addition, in the case of (2), similarly, it is necessary to conceal and sort all category IDs again and update the category value after the category ID is added.

### Solution to Problem

To solve the above problems, according to a first aspect of the present disclosed technology, a secure computation device includes a rank data update unit that specifies an insertion rank of an additional record by a secure comparison operation and updates rank data of a record based on the insertion rank.

According to a second aspect of the present disclosed technology, a secure computation device includes a rank data update unit that updates a rank of a record based on rank data of a deletion record.

### Advantageous Effects of Invention

According to the disclosed technology, it is possible to obtain a secure comparison operation with relatively light processing and rank data updated by addition, without using concealing and sorting with heavy processing.

### BRIEF DESCRIPTION OF DRAWINGS

FIG. 1 is a diagram illustrating an example of a configuration of a secure computation system.

FIG. 2 is a functional block diagram illustrating an example of a configuration of a secure computation device constituting the secure computation system.

FIG. 3 is a diagram illustrating a specific example (content to be solved) of a rank update procedure.

FIG. 4 is a diagram illustrating a specific example (solution method) of the rank update procedure.

FIG. 5 is a diagram for describing a specific example (addition method of a plurality of records) of the rank update procedure.

FIG. 6 is a flowchart for describing an action (record addition) of a rank data update unit.

FIG. 7 is a diagram for describing a specific example (deletion method of a plurality of records) of the rank update procedure.

FIG. 8 is a flowchart for describing an action (record deletion) of the rank data update unit.

FIG. 9 is a flowchart for describing an action of the rank data update unit in a case of a descending rank table.

FIG. 10 is a diagram illustrating an example of a functional configuration of a computer.

### DESCRIPTION OF EMBODIMENTS

Hereinafter, embodiments of the disclosed technology will be described in detail. Note that components having the same functions are denoted by the same reference numerals, and redundant description will be omitted.

### NOTATIONS

The notation in the disclosed technology will be described.
(1) A certain column of a table T is denoted as X.
(2) The value of the column X of a record j in the table T is denoted as Xⱼ.
(3) In N (N≥3) secure computation devices S₀, S₁, . . . , and S_{N-1}, a value (secure distribution value) obtained by encrypting a value a∈Zₙ desired to be concealed is set as [a]ᵢ∈Zₙ. Zₙ is a finite ring including a set of integers from 0 to n (n is an integer of 1 or more). However, since an algorithm is common in each Sᵢ, [a]ᵢ is denoted as [a] without consideration of i as notation of the algorithm.
(4) The encrypted table T is denoted as [T].
(5) The column X of the encrypted table T is denoted as [X].
(6) The value X; of the column X of a record j in the encrypted table T is denoted as [Xⱼ].
(7) The secure addition [c]=add([a], [b]) of the secure distribution values [a] and [b] is denoted as [c]=[a]+[b].
(8) The secure sum [b]=sum([at]) of a secure distribution value sequence [aₖ] is represented by Expression (1).

$$[ Math . 1 ]$$

$$[ b ] = {\sum }_{k} [ {a}_{k} ] \qquad ( 1 )$$

(9) A function of outputting a secure distribution value [f] that is 1 in a case of a>b and 0 in other cases, the function being a secure comparison operation of comparing two secure distribution values [a] and [b] and outputting secure distribution values [0] and [1] indicating a result, is represented by Expression (2).

[Math. 2]

[f]=lessthan([a],[b]) (2)

### First Embodiment

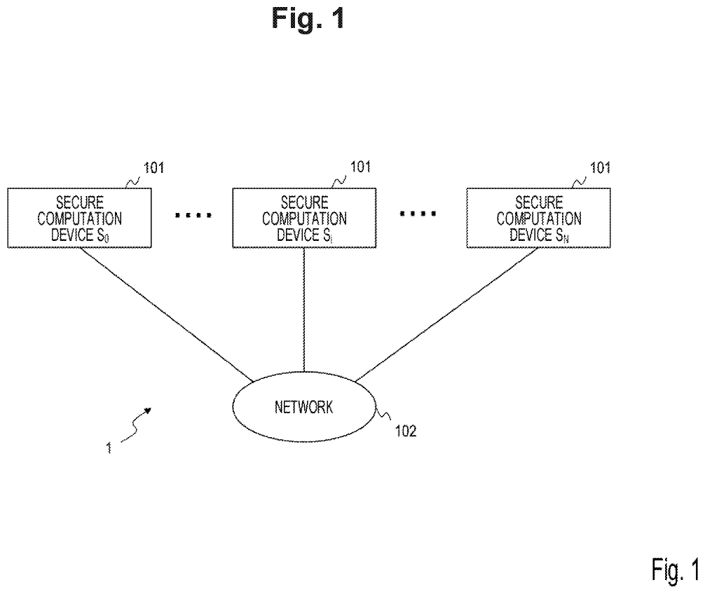

FIG. 1 is a diagram illustrating an example of a configuration of a secure computation system 1 according to the disclosed technology. In the secure computation system 1, N (N≥3) secure computation devices S₀, S₁, . . . , and S_{N-1} are connected via a network 102.

It is assumed that each secure computation device 101 includes a storage unit that stores [T₀], [T₁], . . . , and [Tₓ₋₁] in which tables T₀, T₁, . . . and Tₓ₋₁ desired to be concealed are encrypted (securely distributed), and constitutes a secret distribution system in which original values can be restored by k secure distribution values.

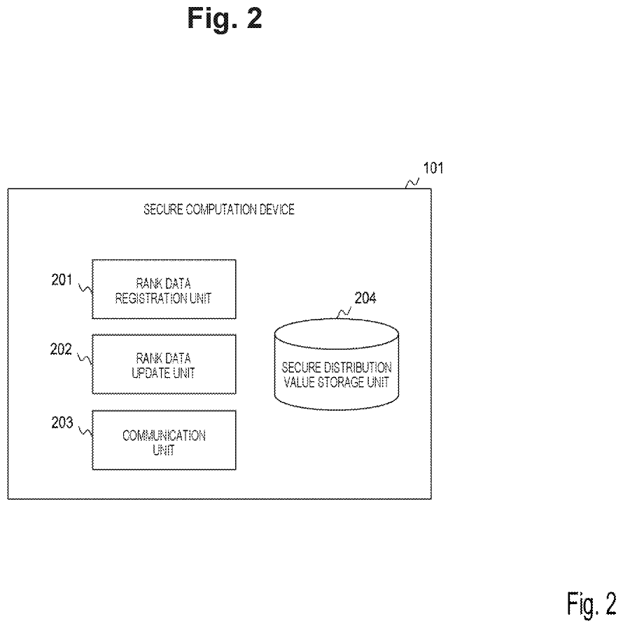

FIG. 2 is a functional block diagram illustrating an example of a configuration of one secure computation device 101. The secure computation device 101 includes a rank data registration unit 201, a rank data update unit 202, a communication unit 203, and a secure distribution value storage unit 204.

The secure computation device 101 performs concealing multiplication, concealing logic operation, and the like in cooperation with another secure computation device by the communication unit 203.

Hereinafter, it is assumed that an encryption table including rank data obtained by the rank data registration unit 201 is stored in advance in the secure distribution value storage unit 204.

### Specific Example 1 of Rank Update Procedure

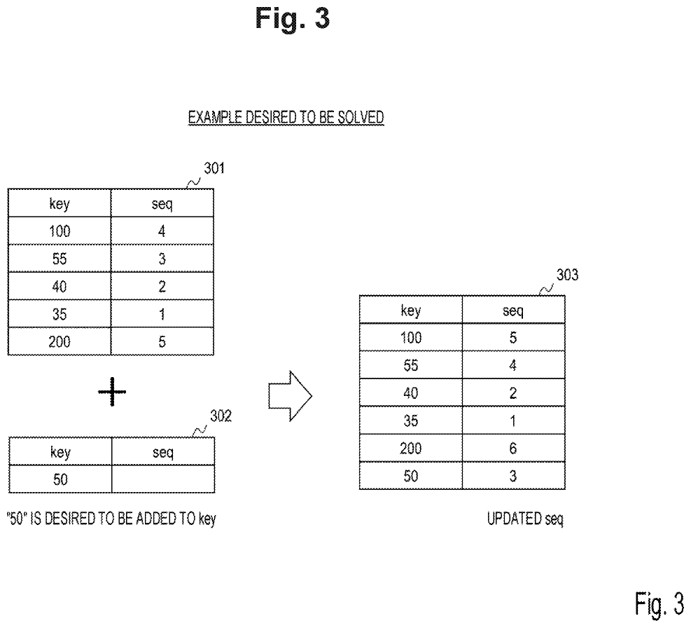

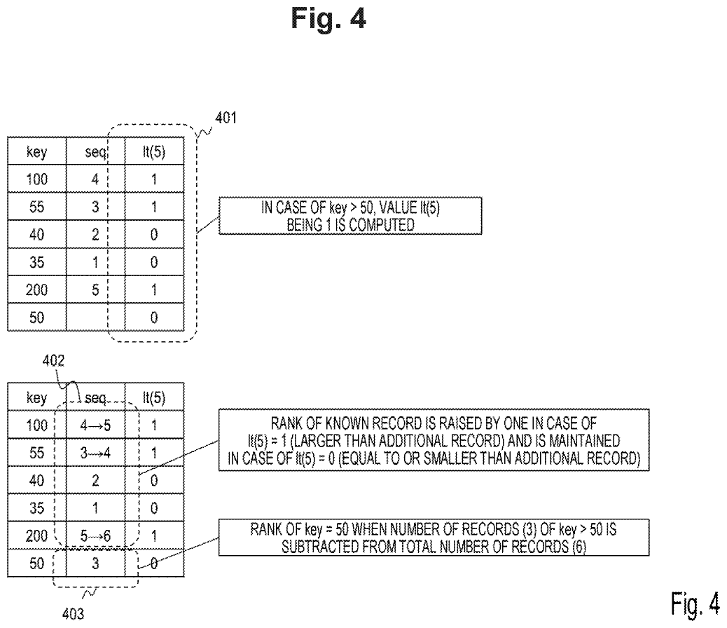

A rank update procedure in a case where one record is added will be specifically described with reference to FIGS. 3 and 4.

FIG. 3 illustrates an “example desired to be solved”. The reference sign 301 denotes a table that has been already stored in the secure distribution value storage unit 204, and quantified data is held in a key column, and a value indicating the rank of the key is held in a seq column.

The reference sign 302 is a record to be desired to be added to the table 301, and a value of the key is 50.

It is desired to add the record 302 to the table 301 and update the rank of the seq column as in a table 303.

Note that the values of the key column and the seq column are correctly values that are securely distributed, and the secure computation defined in the above [notation] is also used for the operation, but plain text values are shown for the convenience of description. The same applies to the following FIGS. 4, 5, and 7.

The process proceeds to FIG. 4. A function lt(5) is computed as indicated by a dotted line frame 401. Here, all key values including the additional record are compared with the key value (=50) of an additional record, and “1” is set in the case of key>50 and “0” is set in the case of key≤50. The “function lt(5)” will be described later.

It is assumed that, as indicated by a dotted frame 402, the rank of the existing record is moved up by one when lt(5)=1 (larger than the additional record), and is maintained when lt(5)=0 (equal to or smaller than the additional record).

The rank of the additional record is obtained by subtracting the number of records (3) having key>50 from the total number of records (6) as indicated by a dotted frame 403.

### Specific Example 2 of Rank Update Procedure

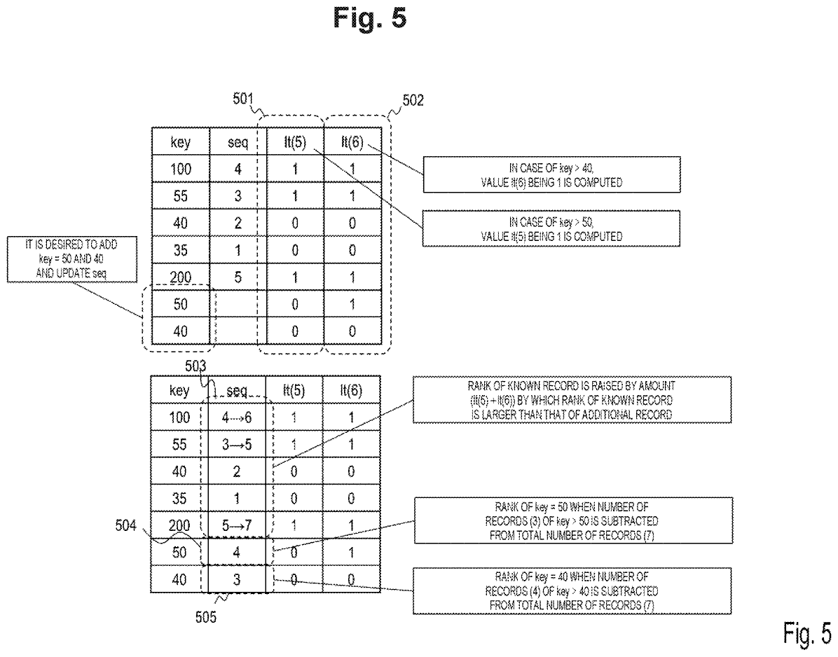

The rank update procedure in a case where two record are added will be specifically described with reference to FIG. 5.

It is assumed that two records having keys of 50 and 40 are desired to be added to the table 301.

The function lt(5) is computed as indicated by a dotted line frame 501. Here, all key values including the additional record are compared with the key value (=50) of an additional record, and “1” is set in the case of key>50 and “0” is set in the case of key≤ 50. Similarly, the function lt(6) is computed as indicated by a dotted line frame 502. Here, all key values including the additional record are compared with the key value (=40) of an additional record, and “1” is set in the case of key>40 and “0” is set in the case of key≤40.

The rank of the existing record is raised by an amount (lt(5)+lt(6)) larger than the additional record, as indicated by a dotted frame 503.

The rank of the additional record in the case of key=50 is obtained by subtracting the number of records (3) having key>50 from the total number of records (7) as indicated by a dotted frame 504.

The rank of the additional record in the case of key=40 is obtained by subtracting the number of records (4) having key>40 from the total number of records (7) as indicated by a dotted frame 505.

### <Addition Procedure of Record>

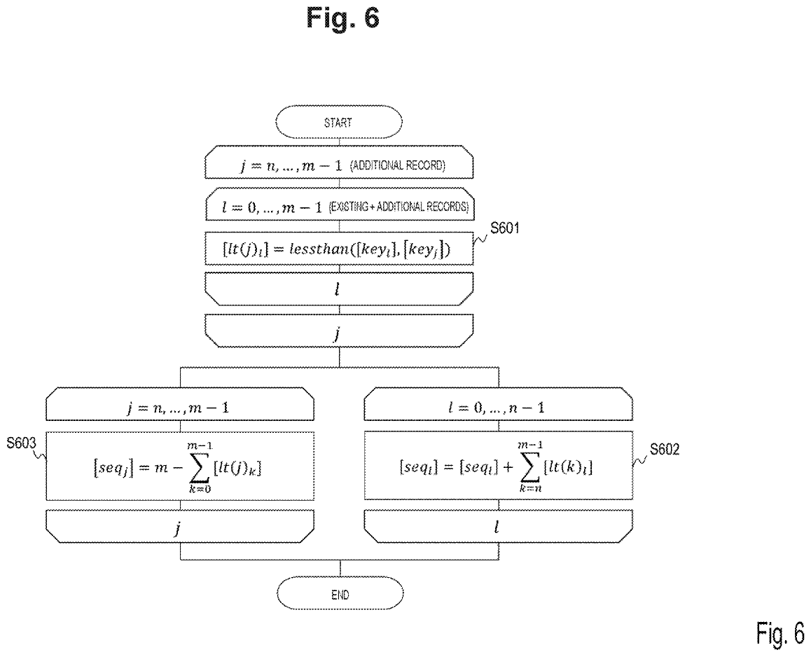

FIG. 6 illustrates a procedure obtained by generalizing the above description. (m-n) records are added to n existing records, and a table including m records is generated.

First, j (=n, n+1, . . . , m−1) is an index for specifying an additional record. Then, l (=0, 1, . . . , m−1) is an index for specifying a total of m existing records and additional records.

Values of key and seq designated by the index k are set as keyₖ and seqₖ, respectively.

A value obtained by performing a secure comparison operation on [keyⱼ] and [keyₗ] is defined as follows.

[Math. 3]

[lt(j)ₗ]=lessthan([keyₗ],[keyⱼ]) (3)

That is, lt(j)ₗ=1 in the case of keyₗ>keyⱼ, and lt(j)ₗ=0 in other cases.

Note that a known secure comparison operation can be used for the present disclosed technology.

The rank data update unit 202 computes Expression (3) for all j and l (Step S601).

The rank data update unit 202 computes (conceals and adds) Expression (4) for l=0, 1, . . . , n−1 to update the seq value of the existing record (Step S602).

$$[ Math . 4 ]$$

$$[ {seq}_{l} ] = [ {seq}_{l} ] + {\sum }_{k = n}^{m - 1} [ {lt ( k )}_{l} ] \qquad ( 4 )$$

The rank data update unit 202 computes (conceals and adds) Expression (5) for j=n, . . . , m−1 to compute the seq value of the additional record (Step S603).

$$[ Math . 5 ]$$

$$[ {seq}_{j} ] = m - {\sum }_{k = 0}^{m - 1} [ {lt ( j )}_{k} ] \qquad ( 5 )$$

The procedure of adding a record to the table has been described above.

### Specific Example 3 of Rank Update Procedure

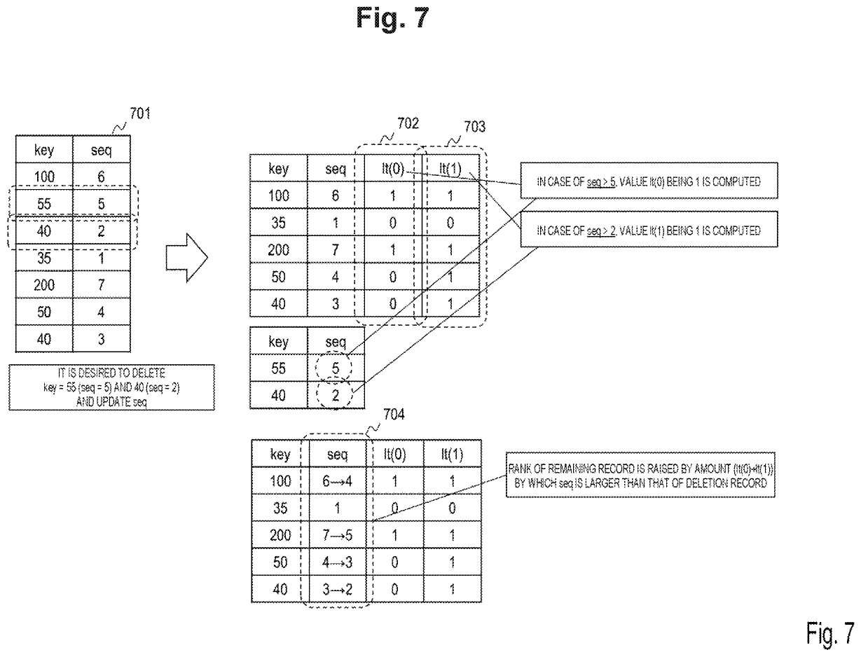

A specific example of the rank update procedure in a case where two record are deleted will be described with reference to FIG. 7.

It is assumed that two records having keys of 55 (seq=5) and 40 (seq=2) are desired to be deleted from a table 701.

The function lt(0) is computed as indicated by a dotted line frame 702. Here, the seq value of the remaining record is compared with the seq value (=5) of a deletion record, and “1” is set in the case of seq>5, and “0” is set in the case of seq≤ 5.

Similarly, the function lt(1) is computed as indicated by a dotted frame 703. Here, the seq value of the remaining record is compared with the seq value (=2) of the deletion record, and “1” is set in the case of seq>2, and “0” is set in the case of seq≤2.

The rank of the remaining record only needs to be raised by an amount (lt(0)+lt(1)) by which the seq value is larger than that of the deletion record, as indicated by a dotted frame 704.

### <Deletion Procedure of Records>

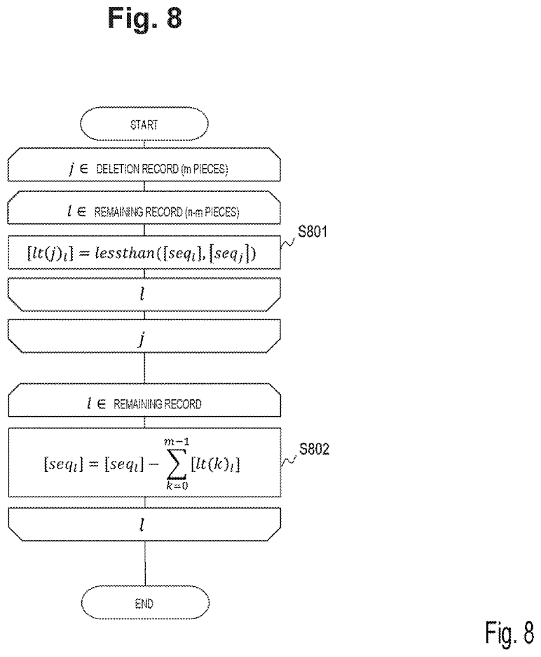

FIG. 8 illustrates a procedure obtained by generalizing the above description. m records are deleted from n existing records, and a table including (n−m) records is generated.

First, j is an index for specifying the deletion record. Then, l is set as an index for specifying the remaining record.

A value obtained by performing a secure comparison operation on [seqⱼ] and [seqₗ] is defined as follows.

[Math. 6]

[lt(j)ₗ]=lessthan([seqₗ],[seqⱼ]) (6)

That is, lt(j)ₗ=1 in the case of seqₗ>seqⱼ, and lt(j)ₗ=0 in other cases.

The rank data update unit 202 computes Expression (6) for all j and l (Step S801).

The rank data update unit 202 computes (conceals and adds) Expression (7) for 1 of (n−m) pieces to update the seq value of the remaining record (Step S602).

$$[ Math . 7 ]$$

$$[ {seq}_{l} ] = [ {seq}_{l} ] - {\sum }_{k} [ {lt ( k )}_{l} ] \qquad ( 7 )$$

Here, k is all indexes for specifying the deletion record.

The procedure of deleting a record from the table has been described above.

### Second Embodiment

In the first embodiment, a case where a record is added to or deleted from a table (ascending rank table) ranked in ascending rank of key data has been described.

In a second embodiment, a case where a record is added to or deleted from a table (descending rank table) ranked in descending rank of key data will be described.

### <Procedure of Adding Record to Descending Rank Table>

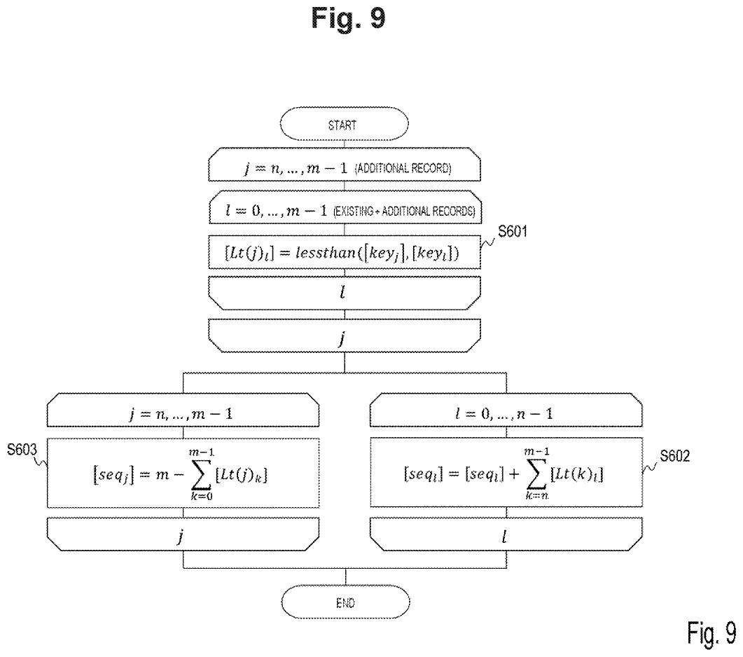

FIG. 9 illustrates the procedure. (m-n) records are added to n existing records, and a table including m records is generated.

First, j (=n, n+1, . . . m−1) is an index for specifying an additional record. Then, l (=0, 1, . . . , m−1) is an index for specifying a total of m existing records and additional records.

Values of key and seq designated by the index k are set as keyₖ and seqₖ, respectively.

A value obtained by performing a secure comparison operation on [keyⱼ] and [keyₗ] is defined as follows.

[Math. 8]

[Lt(j)ₗ]=lessthan([keyⱼ],[keyₗ]) (8)

That is, Lt(j)ₗ=1 in the case of keyⱼ>keyₗ, and Lt(j)ₗ=0 in other cases.

The secure computation device 101 computes Expression (8) for all j and l (Step S901).

The secure computation device 101 computes (conceals and adds) Expression (9) for l=0, 1, . . . , n−1 to update the seq value of the existing record (Step S902).

$$[ Math . 9 ]$$

$$[ {seq}_{l} ] = [ {seq}_{l} ] + {\sum }_{k = n}^{m - 1} [ L {t ( k )}_{l} ] \qquad ( 9 )$$

The secure computation device 101 computes (conceals and adds) Expression (10) for j=n, . . . , m−1 to compute the seq value of the additional record (Step S903).

$$[ Math . 10 ]$$

$$[ {seq}_{j} ] = m - {\sum }_{k = 0}^{m - 1} [ L {t ( j )}_{k} ] \qquad ( 10 )$$

The procedure of adding a record to the descending rank table has been described above.

Note that the procedure of deleting a record from the descending rank table is the same as the procedure of deleting a record from the ascending rank table (first embodiment).

### SUPPLEMENTS

In the above embodiments, in a case where there is no overlapping value among a plurality of keys to be added, appropriate rank data can be assigned. In a case where there is an overlapping value among a plurality of keys to be added, the plurality of keys are divided into units having no overlapping, and this protocol is performed a plurality of times, whereby it is possible to assign appropriate rank data.

### [Program and Recording Medium]

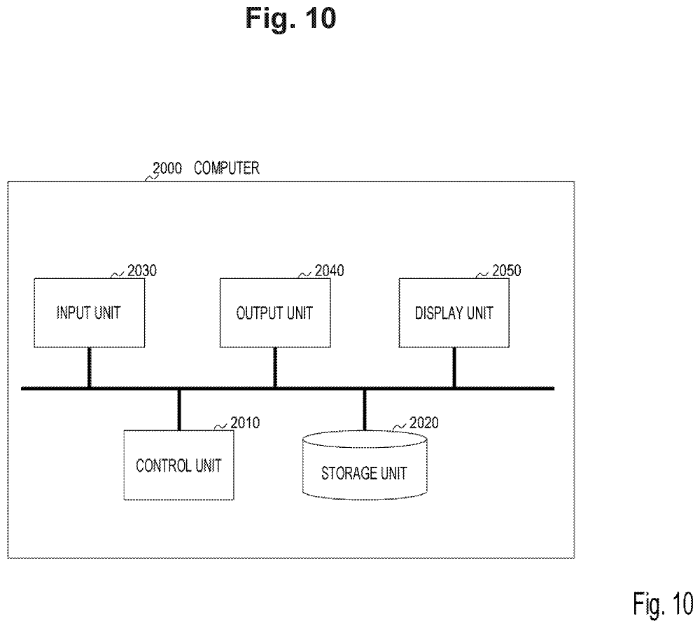

The various processes described above can be performed by causing a recording unit 2020 of a computer 2000 illustrated in FIG. 10 to read a program for executing each step of the method described above and causing a control unit 2010, an input unit 2030, an output unit 2040, a display unit 2050, and the like to operate.

The program describing the processing content may be recorded on a computer-readable recording medium. The computer-readable recording medium may be, for example, any recording medium such as a magnetic recording device, an optical disc, a magneto-optical recording medium, or a semiconductor memory.

In addition, the program is distributed by, for example, selling, transferring, or renting a portable recording medium such as a DVD and a CD-ROM in which the program is recorded. Further, the program may be stored in a storage device of a server computer, and the program may be distributed by transferring the program from the server computer to another computer via a network.

For example, the computer that executes such a program first temporarily stores the program recorded in the portable recording medium or the program transferred from the server computer in the storage device of the own computer. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present aspect includes information used for processing by an electronic computer and equivalent to the program (data or the like that is not a direct command to the computer but has property that defines processing performed by the computer).

Furthermore, although the present device is configured by the predetermined program being executed on the computer in this mode, at least part of the processing content may be implemented by hardware.

### REFERENCE SIGNS LIST

101 Secure computation device
102 Network
201 Rank data registration unit
202 Rank data update unit
203 Communication unit
204 Secure distribution value storage unit
2000 Computer
2010 Control unit
2020 Recording unit
2030 Input unit
2040 Output unit
2050 Display unit

1. A concealing rank update method, the method comprising:
adding a record including key data that is securely distributed, to a table that stores the key data that is securely distributed and rank data that indicates a rank of the key data and is securely distributed, and
updating rank data of the entire table, the concealing rank update method further comprising:
specifying an insertion rank of an additional record by a secure comparison operation; and
updating a rank of a record based on the insertion rank.

2. The concealing rank update method according to claim 1, wherein
the rank is in ascending rank,
the number of records having key data larger than key data of an insertion record is counted while specifying the insertion rank, and
rank data of an existing record is increased by the number of additional records inserted above the existing record.

3. The concealing rank update method according to claim 1, wherein
the rank is in descending rank,
the number of records having key data smaller than key data of an insertion record is counted while specifying the insertion rank, and
rank data of an existing record is increased by the number of additional records inserted above the existing record.

4. A concealing rank update method, the method comprising:
deleting a record from a table that stores key data that is securely distributed and rank data that indicates a rank of the key data and is securely distributed, and
updating rank data of the entire table, the concealing rank update method further comprising:
a rank update step of updating a rank of a record based on rank data of a deletion record.

5. The concealing rank update method according to claim 4, wherein rank data of the remaining record is reduced by the number of deletion records higher than the remaining record.

6. A secure computation device comprising:
at least one processor; and
memory storing instructions that, when executed by the at least one processor, causes the system to perform a set of operations, the set of operations comprising:
adding a record including key data that is securely distributed, to a table that stores the key data that is securely distributed and rank data that indicates a rank of the key data and is securely distributed,
updating rank data of the entire table, the secure computation device comprising a rank update unit that specifies an insertion rank of an additional record by a secure comparison operation, and
updating rank data of a record based on the insertion rank.

7. A secure computation device comprising:
at least one processor; and
memory storing instructions that, when executed by the at least one processor, causes the system to perform a set of operations, the set of operations comprising:
deleting a record from a table that stores key data that is securely distributed and rank data that indicates a rank of the key data and is securely distributed,
updating rank data of an entire table, the secure computation device comprising a rank data update unit that updates a rank of a record based on rank data of a deletion record.

8. A program for causing a computer to execute each step of the concealing rank update method according to claim 1.
